(19) United States
(12) Patent Application Publication
(10) Pub. No.: US 2008/0113742 A1
(43) Pub. Date: May 15, 2008

(54) Game of chance with wild elements and a method and system for providing thereof

(76) Inventors: William George Amos, Moncton (CA); Ginette Lisa Marguerite Belliveau, Moncton (CA)

Correspondence Address: KENYON & KENYON LLP, ONE BROADWAY, NEW YORK, NY, 10004, US

(21) Appl. No.: 11/598,884

(22) Filed: Nov. 13, 2006

(51) Int. Cl. G06F 17/00

(52) U.S. Cl. 463/20; 463/16

(57) ABSTRACT

A system and method are provided for facilitating play of a game of chance. The system may include an input device configured to receive a player indication of a desire to play the game. The system may include a display configured to display a set of displayed game symbols simulating slot machine reels responsive to the player indication, and responsive to a predefined bonus trigger condition, sequentially displaying sets of displayed bonus symbols simulating slot machine reels, wherein each set of displayed bonus symbols includes a quantity of wild symbols. The system may include a processor in communication with the input device and the display, the processor configured to determine the set of displayed game symbols and the sets of displayed bonus symbols based on predefined rules, wherein each displayed game symbol and each displayed bonus symbol is selected from a set of available game symbols, and awarding a prize if a set of displayed bonus symbols are in a predefined symbol pattern, wherein a wild symbol may represent any symbol from the set of available game symbols.

A portion of the disclosure of this patent document contains material which is subject to copyright protection. The copyright owner has no objection to the facsimile reproduction by anyone of the patent document or patent disclosure as it appears in the Patent and Trademark Office patent file or records, but otherwise reserves all copyright rights whatsoever.

### BACKGROUND

A slot machine is a type of game of chance, often offered in casinos or other locations in jurisdictions with legal gambling. Mechanical reel slot machines are coin-operated machines with three or more reels, each reel including a plurality of symbols. The reels spin when a lever on the side of the machine is pulled. The machine accepts a wager from a player and spins the reels. The machine typically pays out a prize based on a pattern of symbols depicted on the reels visible on the front of the machine when the reels stop.

A video slot machine replaces the reels with a video display, such as a CRT or LCD display. The display simulates the reels of a mechanical reel slot machine by displaying a plurality of elements. Each element may depict a symbol and the elements may be animated to simulate spinning reels after a lever on the side of the machine is pulled.

A bonus is a special feature of some slot machines, and may be activated after a bonus trigger condition occurs. For example, the bonus trigger condition may be when certain symbols appear in a pre-defined bonus combination. The bonus trigger condition may also be an appearance of a special bonus trigger symbol.

When the bonus trigger condition occurs at the slot machine, a bonus may be awarded. For example, the player may be presented with several items on a screen from which to choose. As the player chooses items, a quantity of credits is revealed and awarded. Another bonus may use a mechanical device, such as a spinning wheel, that works in conjunction with the bonus to display the amount won. Other bonuses include free spins or other extended play features.

A video gaming machine is an automated kiosk or terminal with an input and an output configured to provide a video game to a player. The video gaming machine may be in communication with a server over a network. The video gaming machine may be configured to provide games of chance to the player and allows the player to bet on the outcome of a video game. Games of chance may include video slots, video poker, video keno, video lottery, or other conventional games of chance.

Video keno is similar to a conventional keno game, but configured to be provided over a video gaming machine to a single player. Conventional keno is a lottery-like or bingo-like gambling game played at casinos and bingo halls. A player chooses anywhere from 1 to 20 player numbers and marks them on a keno ticket of 80 numbers (1 to 80). The casino then draws 20 winning numbers at random. The player is awarded a prize based on his wager and how many player numbers match the winning numbers. Video keno allows the player to choose a set of player numbers from a virtual keno ticket of 80 numbers displayed at the video keno machine. The video keno machine then picks 20 winning numbers at random, and the player wins a prize based on how many player numbers match the winning numbers.

Video poker is similar to a conventional poker game, but configured to be provided over a video gaming machine to a single player. Video poker involves displaying a plurality of simulated poker cards to a player. The player may have the option to discard a quantity of the simulated poker cards, and replacement cards may be dealt to the player. A value of the resulting hand may determine a prize to be awarded to the player.

### BRIEF DESCRIPTION OF THE DRAWINGS

FIG. 1A illustrates an example screen shot of a video slot game, in accordance with an example embodiment of the present invention.

FIG. 1B illustrates an example screen shot of a bonus triggering condition, in accordance with an example embodiment of the present invention.

FIG. 1C illustrates an example screen shot of an entry transition screen, in accordance with an example embodiment of the present invention.

FIG. 1D illustrates a first example screen shot of a bonus game, in accordance with an example embodiment of the present invention.

FIG. 1E illustrates a second example screen shot of a bonus game, in accordance with an example embodiment of the present invention.

FIG. 1F illustrates a third example screen shot of a bonus game, in accordance with an example embodiment of the present invention.

FIG. 1G illustrates an example screen shot of an exit transition screen, in accordance with an example embodiment of the present invention.

FIG. 2 illustrates a first example procedure for providing a game of chance, in accordance with an example embodiment of the present invention.

FIG. 3 illustrates a second example procedure for providing a game of chance, in accordance with an example embodiment of the present invention.

FIG. 4 illustrates an example video gaming machine, in accordance with an example embodiment of the present invention.

FIG. 5 illustrates an example system for providing a game of chance, in accordance with an example embodiment of the present invention.

FIG. 6A illustrates an example pay structure, in accordance with an example embodiment of the present invention.

FIG. 6B illustrates an example pay line structure, in accordance with an example embodiment of the present invention.

### DETAILED DESCRIPTION OF EXAMPLE EMBODIMENTS

An example embodiment of the present invention may include a system and method for providing a game of chance to a player, for example, a video slot game. The video slot game may display a set of displayed symbols responsive to a player indicating a desire to play the game and depositing a wager. The displayed symbols may be selected from an pool of available symbols. A prize may be awarded if a prize trigger condition is met, for example, that the displayed symbols are in a predefined winning pattern after a spin in the video slot game. In addition, the game of chance may award the player a bonus game if a bonus triggering condition is met. The bonus game may include a plurality of bonus spins, each spin including a quantity of wild symbols. A wild symbol may take on the value of any symbol in the pool of available symbols for purposes of determining whether a prize is awarded to the player.

In another example embodiment of the present invention, a system for facilitating play of a game of chance may be provided. The system may include an input device configured to receive a player indication of a desire to play the game. The system may include a display configured to display a set of displayed game symbols simulating slot machine reels responsive to the player indication, and responsive to a predefined bonus trigger condition, sequentially displaying sets of displayed bonus symbols simulating slot machine reels, wherein each set of displayed bonus symbols includes a quantity of wild symbols. The system may include a processor in communication with the input device and the display, the processor configured to determine the set of displayed game symbols based on predefined rules, wherein each displayed game symbol is selected from a set of available game symbols, determine the sets of displayed bonus symbols based on the predefined rules, wherein each displayed bonus symbol is selected from the set of available game symbols, and awarding a prize if a set of displayed bonus symbols are in a predefined symbol pattern, wherein a wild symbol may represent any symbol from the set of available game symbols. The bonus trigger condition may be the set of displayed game symbols being in a predefined bonus trigger pattern. The bonus trigger condition may be the set of displayed game symbols including a bonus trigger symbol. The quantity of wild symbols may increase after each set of bonus spin symbols. Each wild symbol may replace one of the displayed bonus symbols after the displayed bonus symbols are displayed. Each wild symbol may be associated with a display location and replace a displayed bonus symbol associated with the display location after the displayed bonus symbols are displayed. The wild symbols may be added to the displayed bonus symbols before the displayed bonus symbols are displayed. The system may include a dispenser for dispensing the prize to the player. The system may include a prize structure, the prize structure mapping a predefined winning set of bonus symbols with a prize. The system may include a payment receiving device for receiving a payment from the player prior to displaying the set of displayed game symbols, the payment receiving device communicating to the processor that the payment has been received. The system may include a network interface in communication with a server over a network. The network may be the Internet. The processor may be located at the server, and the network interface, the input device, and the display may be located at a terminal.

Another embodiment of the present invention may be a method for facilitating play of a game of chance. The method may include, responsive to a player indication of a desire to play the game, displaying a set of displayed game symbols to the player. The method may include, responsive to a bonus trigger condition, sequentially displaying sets of displayed bonus symbols to the player, each set of bonus symbols including a quantity of wild symbols. The method may include awarding a prize to the player, wherein the prize is determined based on the sets of displayed bonus symbols. The bonus trigger condition may occur when the set of displayed game symbols are in a predefined bonus trigger pattern. The bonus trigger condition may occur when a bonus trigger symbol is displayed with the displayed game symbols. The quantity of wild symbols may increase from one set of displayed bonus symbols to the next. Each wild symbol may replace one of the displayed bonus symbols after the displayed bonus symbols are displayed. Each wild symbol may be associated with a display location and replace a displayed bonus symbol associated with the display location after the displayed bonus symbols are displayed. The wild symbols may be added to the displayed bonus symbols before the displayed bonus symbols are displayed. The method may include dispensing the prize to the player from a dispenser. The prize may be determined by looking up a prize structure, the prize structure mapping a predefined winning set of displayed bonus symbols with a prize. The method may include receiving a payment from the player prior to providing the game of chance. The method may include a network interface in communication with a server over a network. The network may include the Internet. The game of chance may be a video keno game, and the displayed game symbols and the displayed bonus symbols may be keno spots. The game of chance may be a video poker game, and the displayed game symbols and the displayed bonus symbols may be virtual poker cards. The game of chance may be a video slot machine game, and the displayed game symbols and the displayed bonus symbols may simulate slot machine wheels.

Another example embodiment of the present invention may be a computer readable medium including instructions configured to be executed on a processor, so that the processor performs the steps a method for facilitating play of a game of chance. The method may include, responsive to a player indication of a desire to play the game, displaying a set of displayed game symbols to the player. The method may include, responsive to a bonus trigger condition, sequentially displaying sets of displayed bonus symbols to the player, each set of bonus symbols including a quantity of wild symbols. The method may include awarding a prize to the player, wherein the prize is determined based on the sets of displayed bonus symbols.

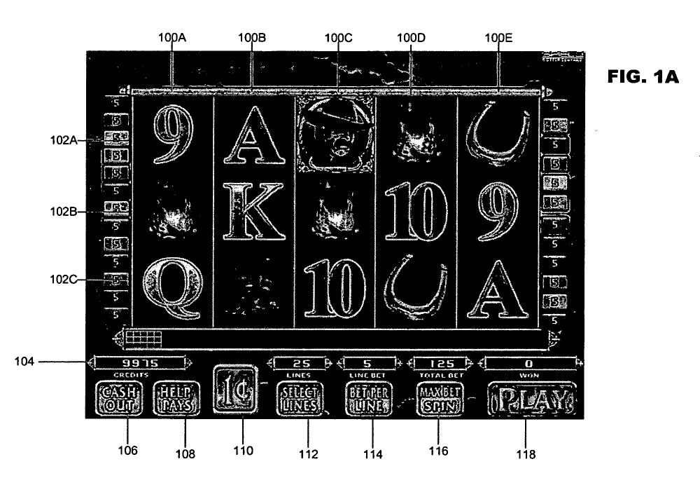

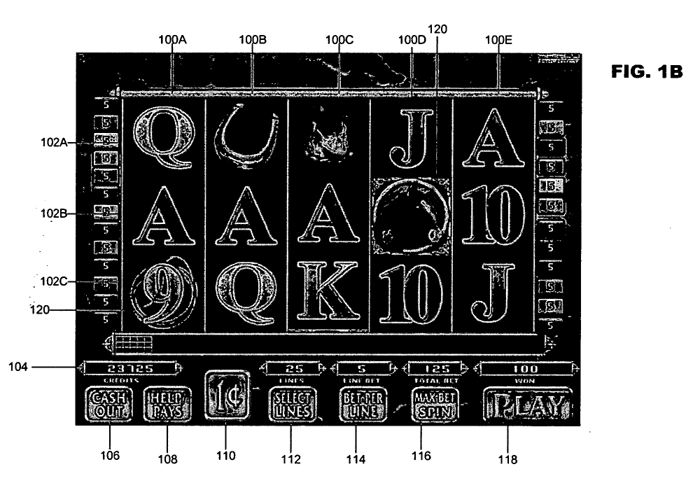

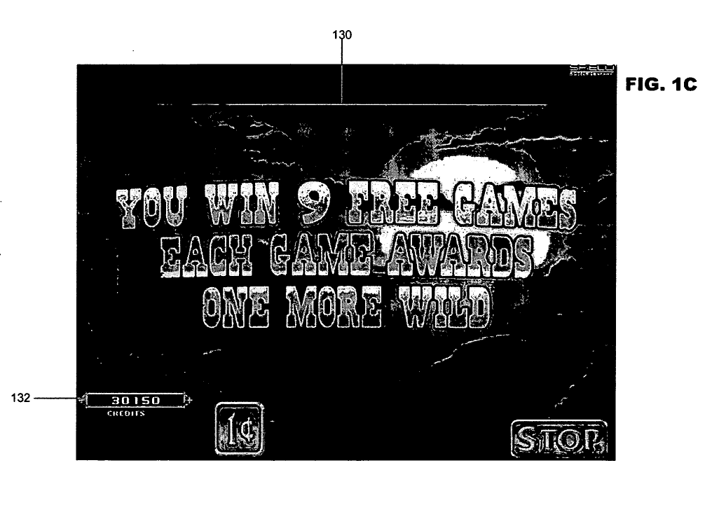

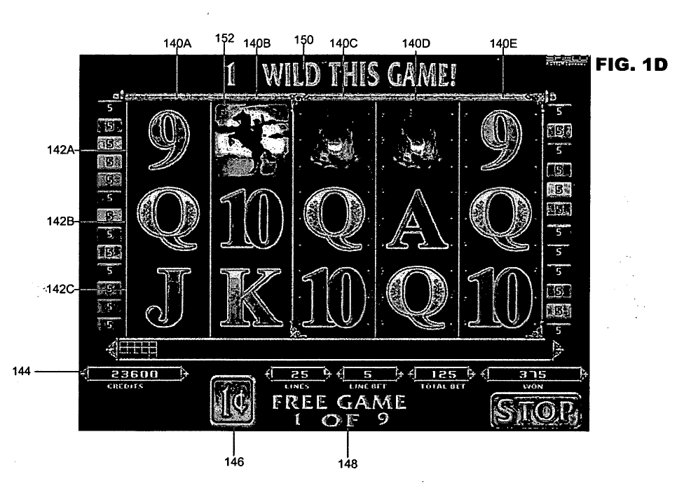

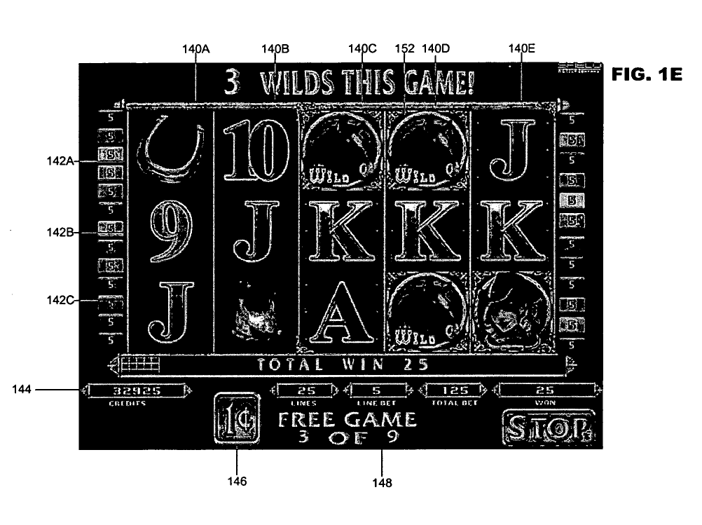

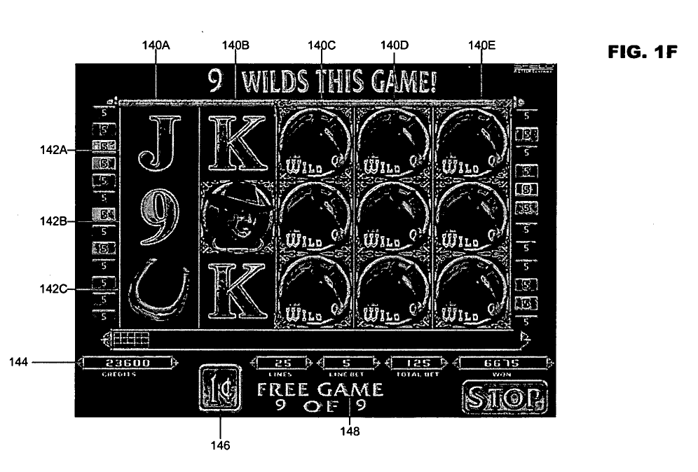

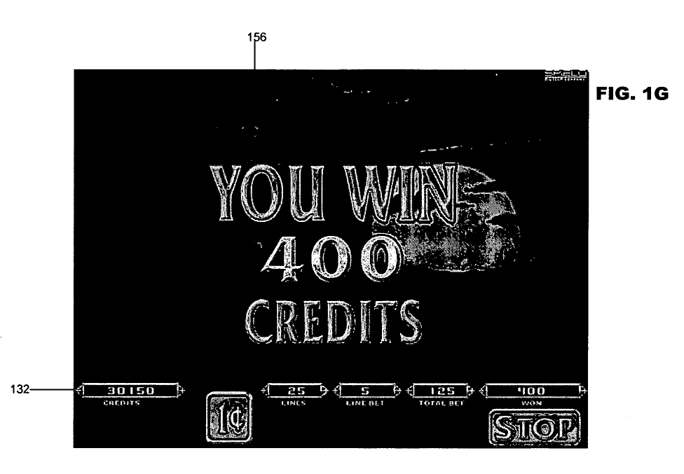

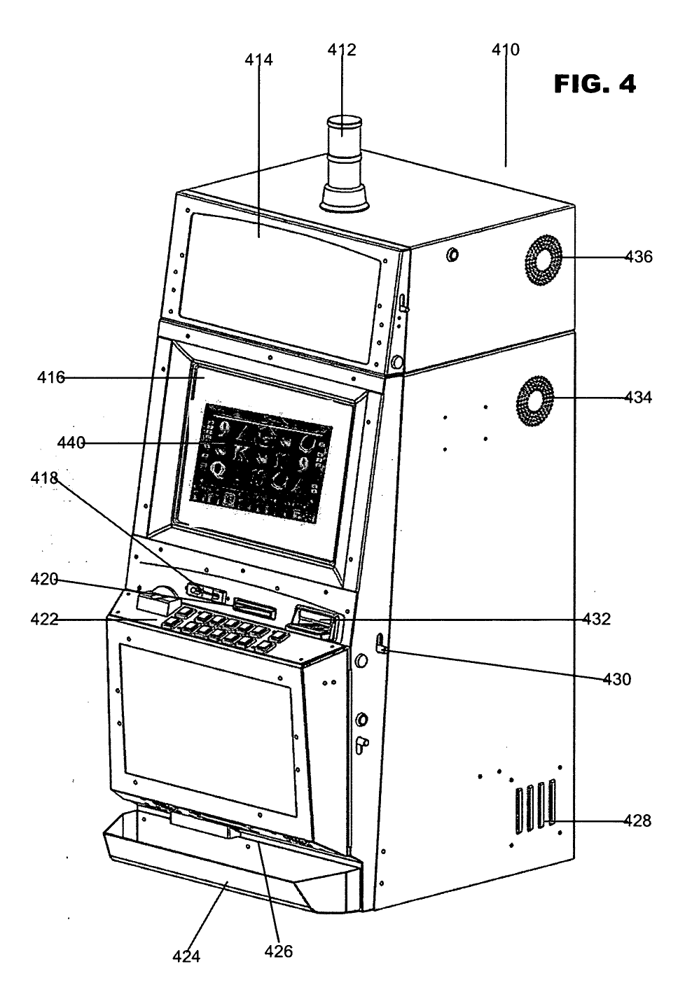

FIG. 1A illustrates an example screen shot of a video slot game, in accordance with an example embodiment of the present invention. The screen shot may be displayed on a monitor display of a video gaming machine (VGM) as depicted in FIG. 4.

While the subsequent figures depict screen shots as displayed on a VGM, it will be understood that the game described in this and the subsequent figures may be adapted for execution on a mechanical slot machine. For example, the reels on the mechanical slot machine may be configured to display a wild symbol as required. Alternatively, the rigid covering on the reels may be a transparent display, able to display a wild symbol as required.

The VGM may be configured to provide a video slot game as described in the following figures. The video slot game may be provided to a player, who selects a wager amount and the VGM determines an outcome, either winning or losing. A winning outcome may provide a regular award, for example, currency or some other valuable consideration. Alternatively, a winning outcome may provide an award of a bonus game, as described in this and the following figures. It will be appreciated that other types of games may be provided in place of a video slot game, for example, video roulette, video poker, video keno, or other simulated casino games, simulated races, simulated card games, etc.

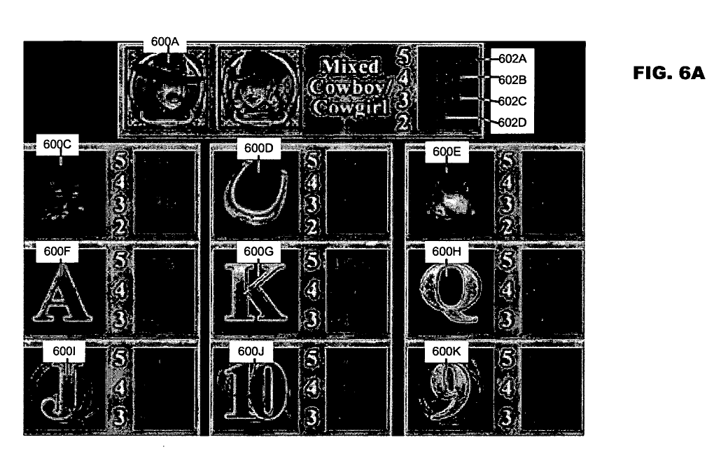

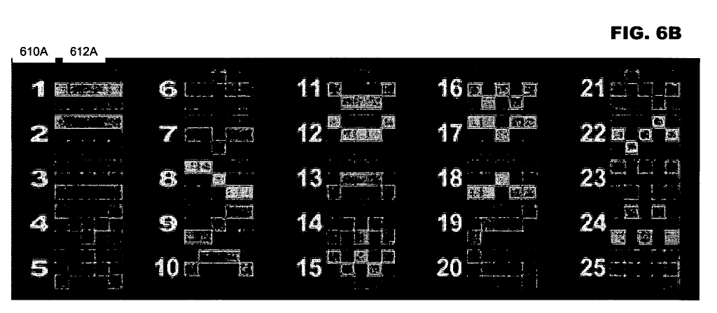

The video slot game may include a plurality of elements, each element displaying a symbol. The elements may be arranged into columns and rows. For example, the video slot game may include five columns 100A, 100B, 100C, 100D, and 100E. The video slot game may include three rows 102A, 102B, and 102C. Each element displayed at the VGM may be associated with a column and a row. For example, FIG. 1A includes 15 elements, each element displaying a symbol. The symbols may be selected from a plurality of available symbols in the game. For example, available symbols in the game may be as depicted in FIG. 6A.

The VGM may award a prize if the symbols end in a predefined winning pattern after a spin. For example, predefined winning patterns may be as depicted in FIG. 6A, where a quantity of a symbol appearing on a pay line depicted in FIG. 6B is a predefined winning pattern. Prizes may be anything of value, for example, cash, monetary awards, merchandise, game credits, or bonus games. One example prize may be a bonus game. A bonus game may include a plurality of bonus spins. The bonus spins may include a quantity of symbols and wild symbols. A wild symbol may represent any available symbol in the game for purposes of determining whether the symbols in the bonus spin are in a predefined winning pattern. The quantity of wild elements may increase from one bonus spin to the next. For example, this and the subsequent figures depict a bonus game including nine bonus spins, each bonus spin including one more wild symbol than the previous bonus spin. Thus, the first bonus spin result includes one wild symbol, the second bonus spin includes two wild symbols, until the ninth bonus spin includes nine wild symbols.

In an alternative embodiment, the wild symbols may replace symbols after the spin results are displayed. In an alternative embodiment, the wild symbols may be added to a pool of symbols from which the displayed symbols are selected from before being displayed. For example, a quantity of symbols may be also removed from the pool, the quantity equal to the quantity of wild symbols added to the pool.

In one embodiment, the bonus spins may occur one after another automatically, with a predetermined pause between each bonus spin. In another embodiment, the bonus spins may occur responsive to a player input, for example, pressing a “spin” button.

The player may be awarded any prizes resulting from the bonus spins. For example, the prizes may be awarded as they are won after the symbols are in a predefined winning pattern at the end of each spin. Alternatively, the prizes may be awarded at the end of the sequence of bonus games.

A credits indicator 104 may indicate a quantity of credits available to the player. For example, credits may represent be currency won or paid to play in the game, and may be used to purchase wagers. Credits may be purchased by the player who submits currency to the game of chance. Prizes may also be awarded in credits. Credits may also be counted within the VGM in a base denomination, such as one cent, five cents, twenty-five cents, fifty cents, or a dollar. The denomination may be used to describe the VGM, for example, a penny-slot, a nickel-slot, a quarter-slot, a half-dollar-slot, or a dollar-slot.

A cash out button 106 may receive a player indication to cash out the player's credits. For example, the player may cash out his credits when he is finished with his gaming session and wishes to leave the VGM. For example, the credits may be dispensed from the VGM as currency or as a voucher redeemable at a cashier for currency or other prizes. Alternatively, the prize may be dispensed after each play.

It is understood that the screen shot of FIG. 1A may also be displayed on a touch-sensitive display, and the player may directly press the area of the displayed cash out button 106. In an alternative embodiment, the VGM may include buttons underneath the depicted buttons for receiving the player's inputs. This may apply to all buttons depicted on the screen shot.

A help/pays button 108 may display help screens to the player, including the pay structure and pay lines as depicted in FIGS. 6A and 6B. The help screens may include instructions on how to play the game as well as any other helpful information.

A denomination indicator 110 may indicate to the player the denomination of the VGM. The denomination indicator 110 may be prominently displayed to be visible to players browsing past the VGM.

A select lines button 112 may allow the player to select a quantity of lines to be played on the VGM. Each line may be a collection of elements that are checked for a winning pattern of symbols. For example, the lines in the VGM may be as depicted in FIG. 6B. A prize may be awarded on a line if a set of elements associated with the line display symbols in a predefined winning pattern. With multiple lines, the player may have multiple ways to win on one spin of the virtual reels.

In an alternative embodiment, the VGM may award a prize, wherein the prize depends on the winning pattern of the symbols and a quantity of lines wagered.

The VGM may cycle through available lines in the game of chance responsive to the player pressing the select lines button 112.

A bet per line button 114 may allow the player to select a bet to be placed on each line. For example, the bet may vary between one credit and a predefined maximum quantity of credits acceptable at the VGM.

A max bet spin button 116 may be a shortcut button allowing the player to select the maximum bet available on all selected lines and immediately spin the reels on the VGM. This may save the player time from selecting a bet per line and indicating to the VGM to spin the virtual reels.

The game may be played when the player indicates a quantity of lines to play, a bet amount for each line, and presses the play button 118. The game may proceed by the VGM animating the elements in columns 100A, 100B, 100C, 100D, and 100E to simulate reels in a mechanical reel slot machine. For example, the columns may be animated to simulate the elements randomly spinning on slot machine reels. The animation may finish with symbols in a resulting pattern, where the resulting pattern may be determined randomly, randomly within predefined bounds, or in another predetermined manner. The resulting pattern may be a winning pattern or a losing pattern. The VGM may award a prize when a winning pattern occurs and display a consolation message or do nothing when a losing pattern occurs.

It will be understood that any pattern of symbols may be predefined to trigger the bonus game. In an alternative embodiment, the bonus game may be trigged by another triggering condition, for example, when a predetermined quantity of games have been played on the VGM. In an alternative embodiment, the bonus game may be triggered by an appearance of a special bonus trigger symbol.

A play button 118 may allow the player to spin the virtual reels on the VGM. It will be appreciated that an alternative input device may be used, for the player to indicate their desire to play the game.

It will be understood that while a video slot game is depicted in this and the following figures, alternative embodiments include video poker, video keno, video lottery, or any other video game of chance where bonus games can be awarded and can include wild symbols.

FIG. 1B illustrates an example screen shot of a bonus triggering condition, in accordance with an example embodiment of the present invention. The screen shot may include many of the same features of FIG. 1A, for example, the buttons, symbols, and elements. FIG. 1B includes a bonus game trigger symbol 120. For example, the bonus game triggering condition may be an appearance of the bonus game trigger symbol 120 in the elements. The appearance of the bonus game trigger symbol 120 may trigger the bonus game, as depicted in the subsequent figures. As discussed above, the bonus triggering condition may be any other condition, such as the appearance of a special bonus trigger symbol, a number of plays previously executed on the VGM, or any other condition.

FIG. 1C illustrates an example screen shot of an entry transition screen, in accordance with an example embodiment of the present invention. After a bonus game is awarded, the transition screen of FIG. 1C may be displayed to the player. The transition screen may include a graphics 130, which includes visually attractive graphics that also describe the bonus game to the player.

For example, the bonus game may include a plurality of bonus spins available to the player at no additional cost or wager. Each bonus spin may include a quantity of wild symbols, each wild symbol able to take on the value of any symbol available in the game for purposes of determining a prize to award the player. For example, the wild symbol may increase the probability that the player will win a prize by increasing the probability that the symbols will match a predefined winning pattern.

The prize structure in the game of chance may describe prize trigger conditions. For example, a prize trigger condition may be a predefined quantity of a specified symbol appearing along a predefined pay line in the game. A wild symbol appearing along the predefined pay line may represent the specified symbol, thus awarding the player the associated prize.

A credits indicator 132 may indicate a quantity of credits available to the player. For example, credits may be currency in the game, used to purchase wagers. Prizes may also be awarded in credits. Credits may also be counted within the VGM in a base denomination, such as a penny, a nickel, a quarter, a half-dollar, or a dollar. The denomination may be used to describe the VGM, for example, a penny-slot, a nickel-slot, a quarter-slot, a half-dollar-slot, or a dollar-slot.

FIG. 1D illustrates a first example screen shot of a bonus game, in accordance with an example embodiment of the present invention. After a bonus game is awarded and the transition screen of FIG. 1B has been displayed to the player, the bonus game may begin.

The bonus game may provide a game similar to the previous video slot game played on the VGM. Alternatively, other forms of bonus games may be provided, for example, simulated casino games such as roulette, card games, races, etc. The VGM displays a set of elements, each element displaying a symbol. The set of elements may be arranged into columns 140A, 140B, 140C, 140D, and 140E. The set of elements may also be arranged into rows 142A, 142B, and 142C. Each spin of the virtual reels may be similar to a regular spin in the game of chance, except a quantity of elements that are displayed may be wild symbols.

A credits indicator 144 may indicate a quantity of credits available to the player, similar to the credit indicator depicted in FIG. 1A. For example, credits may be currency in the game, used to purchase wagers. Prizes may also be awarded in credits. Credits may also be counted within the VGM in a base denomination, such as a penny, a nickel, a quarter, a half-dollar, or a dollar. The denomination may be used to describe the VGM, for example, a penny-slot, a nickel-slot, a quarter-slot, a half-dollar-slot, or a dollar-slot.

A denomination indicator 146 may indicate to the player the denomination of the VGM, similar to the denomination indicator depicted in FIG. 1A. The denomination indicator 146 may be prominently displayed to be visible to players browsing past the VGM.

A bonus spins remaining indicator 148 may indicate to the player the quantity of bonus spins remaining. The bonus spins remaining indicator 148 may be a counter, incrementing every time a bonus spin is made.

A wild symbol quantity counter 150 may indicate a quantity of wild symbols available in the spin. The wild symbol quantity counter 150 may increment after every spin in the bonus game.

FIG. 1E illustrates a second example screen shot of a bonus game, in accordance with an example embodiment of the present invention. After a winning spin bonus is awarded and a special winning spin has been provided by the VGM in FIG. 1C, a winning spin may result.

In one embodiment, the bonus spins may occur in series with no more input from the player. In another embodiment, the player may be required to provide an input to continue after each bonus spin.

The screen shot may include similar features as FIG. 1D, including counters, elements, and symbols.

A wild symbol 152 may be displayed in the bonus game. In this screen shot, three wild symbols are displayed to the player. The wild symbol 152 may represent any available symbol in the game for purposes of determining whether the player is to be awarded a prize. For example, in a western themed game, as illustrated, the wild symbol 152 may be a horse with “wild” text.

The wild symbol 152 may be associated with a display location. For example, the display location may be randomly selected by the game, or predetermined.

The wild symbol 152 may be displayed to the player after a spin result is displayed. For example, the wild symbol 152 may overwrite an existing symbol after the spin result. In an example embodiment, the game may determine whether any prizes are to be awarded after the spin result. The wild symbol 152 is then displayed, and the game again determines whether any prizes are to be awarded, taking into account the wild symbol 152. In another example embodiment, the game may determine whether any prizes are to be awarded only after the wild symbols have been displayed.

The wild symbol 152 may appear before the spin result and remain stationary during the spin. The wild symbol 152 may be added to a pool of symbols from which the displayed symbols are selected.

In one example embodiment, the wild symbols may be added randomly to the three rightmost columns of elements. In an alternative embodiment, the wild symbols may be added to any element displayed by the game. The location of wild symbols may be selected randomly or in accordance with predefined rules.

The bonus spins remaining indicator 148 may indicate that this is the third bonus spin in the bonus game. The screen shots depicted in the figures may illustrate the first, third, and ninth bonus spin result screen shots. It will be understood that five other spins (second, fourth, fifth, sixth, seventh, and eighth) may also be provided to the player, though not depicted in the figures.

FIG. 1F illustrates a third example screen shot of a bonus game, in accordance with an example embodiment of the present invention. The screen shot may be similar to FIG. 1E, except nine wild symbols are displayed to the player instead of three. The bonus spins remaining indicator 148 may indicate that all 9 of the awarded bonus spins have been completed, and thus the bonus game has been completed.

FIG. 1G illustrates an example screen shot of an exit transition screen, in accordance with an example embodiment of the present invention. After the bonus game is over, for example, by providing all of the awarded bonus spins, the transition screen of FIG. 1G may be displayed to the player. The transition screen may include a graphics 156, which includes visually attractive patterns that a congratulatory message. For example, the graphics 156 may describe the quantity of credits awarded to the player.

A credits indicator 132 may indicate a quantity of credits available to the player. The credits indicator 132 may reflect the prize awarded to the player after the bonus game.

For example, credits may be currency in the game, used to purchase wagers. Prizes may also be awarded in credits. Credits may also be counted within the VGM in a base denomination, such as a penny, a nickel, a quarter, a half-dollar, or a dollar. The denomination may be used to describe the VGM, for example, a penny-slot, a nickel-slot, a quarter-slot, a half-dollar-slot, or a dollar-slot.

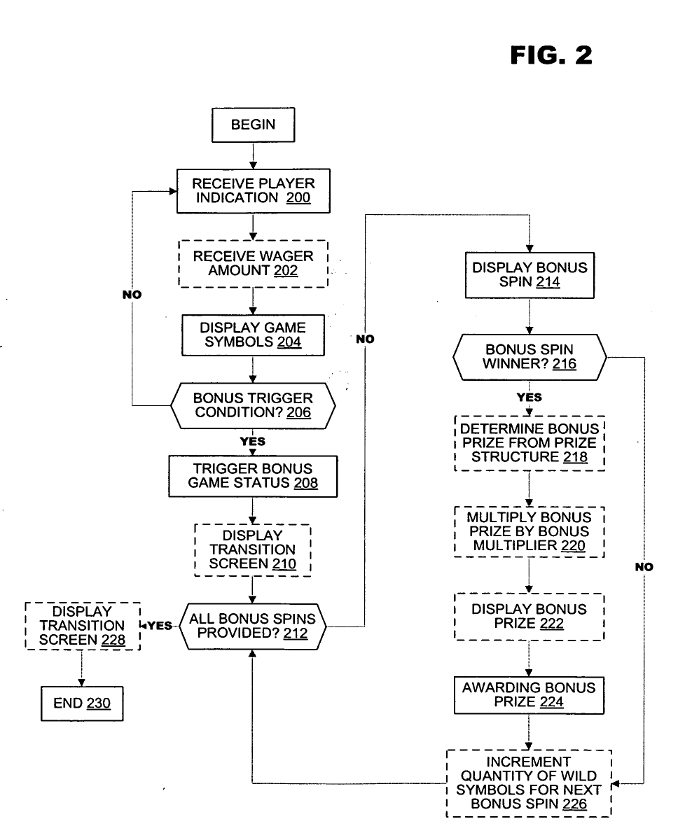

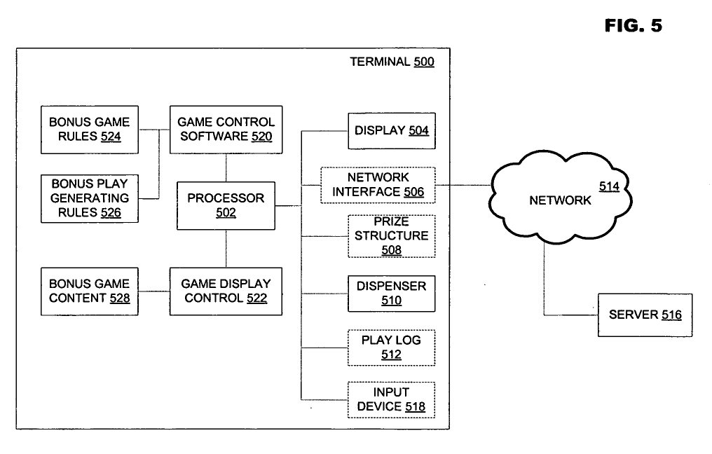

FIG. 2 illustrates a first example procedure for providing a game of chance, in accordance with an example embodiment of the present invention. The procedure may execute on a terminal (VGM) as depicted in FIG. 4 within a system as depicted in FIG. 5. The procedure may provide a game of video slots to a player.

The terminal may be controlled locally or remotely from a server. If controlled locally, the terminal may be a stand-alone kiosk configured to provide a game of chance to a player. If controlled remotely, the terminal may be in communication with a server over a network, such as a private network, a virtual private network, or the Internet. The central server may control a plurality of terminals, for example, distributed over different geographical locations.

In 200, the terminal may receive a player indication of a desire to play the game. For example, the player may press a button on the VGM to begin the game.

In 202, the terminal may optionally receive a wager from the player. For example, the terminal may include a wager acceptor that receives a credit card, a debit card, a pre-paid card, currency, coins, a printed voucher, or another form of payment. The player may additionally input a wager amount via input at the terminal. The terminal may wait at 202 until a wager amount has been received.

In 204, the terminal may display game symbols to the player. For example, game symbols may be reel symbols in the video slot machine game. The reel symbols may be arranged in a plurality of columns simulating reels on a mechanical reel slot machine.

In an alternative embodiment, the procedure may execute on a mechanical reel slot machine.

In 206, the terminal may test whether a bonus trigger condition has been met. For example, the bonus trigger condition may be a predefined winning pattern for the reel symbols displayed in 204. For example, the bonus condition may be as depicted in FIG. 1B.

Alternatively, the bonus trigger condition may be unrelated to the reel symbols, such as a count of total games played on the terminal, a predetermined time, or any other condition. If the bonus trigger condition has occurred, the terminal may proceed to 208 where a bonus game may be awarded.

If the bonus trigger condition has not occurred, the terminal may award any prizes won by the player based on the reel symbols. The terminal may then proceed to 200 and await another game. The player may immediately begin another game.

In 208, the terminal may trigger a bonus game status. For example, the bonus game status may include special lights on the terminal indicating the bonus game status. For example, the bonus game may include a predetermined number of bonus spins, each spin including an increasing number of wild symbols.

In 210, the terminal may optionally display a transition screen into the bonus game. For example, the transition screen may be as depicted in FIG. 1C.

In 212, the terminal may test whether all bonus spins have been provided. If yes, the terminal may proceed to 228, where an exit transition screen is displayed. If no, the terminal may proceed to 214.

In 214, the terminal may display a bonus spin. For example, the bonus spin may be similar to a regular spin on the terminal, with the addition of a quantity of wild symbols in the results. For example, the bonus spin may result in a screen as depicted in FIGS. 1D, 1E, and 1F.

In 216, the terminal may determine whether the bonus spin resulted in a predetermined winning pattern. If so, the player may be entitled to a bonus prize and procedure may continue with 218. For example, wild symbols may represent any available symbol in the video slot game for purposes of determining whether a prize is to be awarded to the player. If no prize is awarded, the terminal may proceed to 226.

In 218, the terminal may optionally determine the bonus prize from a prize structure. For example, the prize structure may be as depicted in FIGS. 6A and 6B. It will be appreciated that any mapping, using conventional data structures, between outcomes and prizes may be employed. A prize may be awarded if a quantity of the same symbols occurs on a pay line selected by the player.

In 220, the terminal may optionally multiply the bonus prize by a bonus multiplier. For example, the bonus multiplier may be previously awarded to the player responsive to a multiplier award trigger condition.

In 222, the terminal may optionally display the bonus prize won by the player. For example, the quantity of the prize may be displayed on a display of the terminal.

In 224, the terminal may award the bonus prize. For example, the bonus prize may be added to a cumulative bonus prize to be awarded at the end of the bonus game.

In an alternative embodiment, the terminal may dispense the bonus prize through a dispenser. For example, the bonus prize may be dispensed as currency, currency, a printed voucher, merchandise, or some other form of value. In 226, the terminal may optionally increment a quantity of wild symbols for the next bonus spin.

In 228, the terminal may display an exit transition screen, for example, as depicted in FIG. 1G.

In 230, the procedure may end.

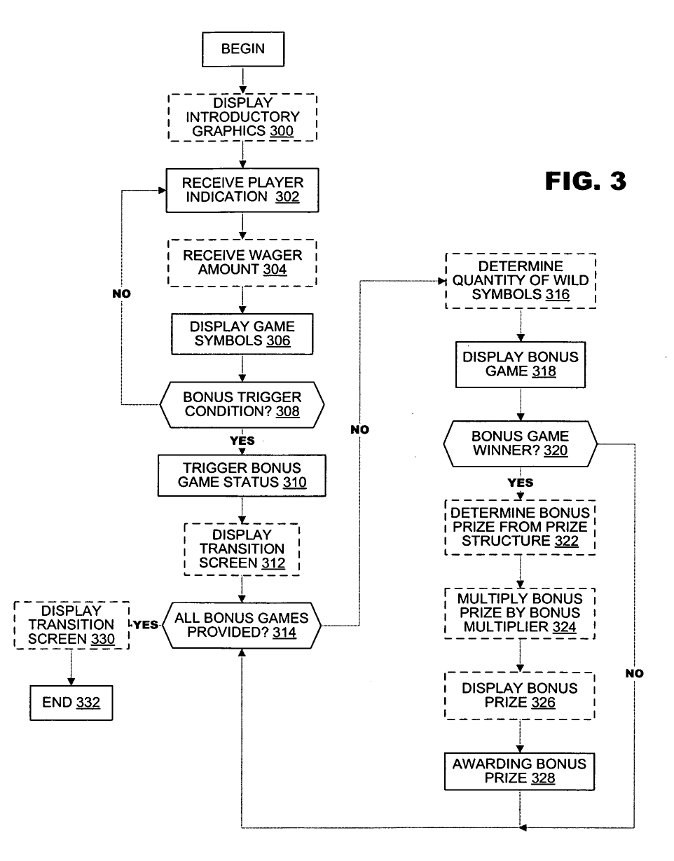

FIG. 3 illustrates a second example procedure for providing a game of chance, in accordance with an example embodiment of the present invention. The procedure may provide a game of chance or a wagering game to a player. The game may involve receiving a wager from the player, displaying a plurality of game symbols including a quantity of wild symbols, determining an outcome of the wager, and awarding a prize to the player. For example, the game may be a slot machine game, a video poker game, a video keno game, a lottery game, or any other game. The procedure may execute on a game terminal configured to interact with the player.

In 300, the terminal may optionally display introductory graphics. For example, introductory graphics may be visually attractive graphics designed to attract potential player's attention and encourage game play. The introductory graphics may also explain the highlights of the game and provide access to help screens.

In 302, the terminal may receive a player indication of a desire to play the game. For example, the player may press a button on the terminal to begin the game.

In 304, the terminal may receive a wager amount from the player. For example, the terminal may include a wager acceptor that receives a credit card, a debit card, a pre-paid card, currency, coins, a printed voucher, or another form of payment. The player may additionally input a wager amount via input at the terminal. The terminal may wait at 304 until a wager amount has been received.

In 306, the terminal may display game symbols to the player. For example, game symbols may be reel symbols in the video slot machine game. The reel symbols may be arranged in a plurality of columns simulating reels on a mechanical reel slot machine.

In an alternative embodiment, the game may be a video poker game, and the game symbols may simulate poker cards. In an alternative embodiment, the game may be a video keno game, and the game symbols may represent a virtual keno card.

In 308, the terminal may test whether a bonus trigger condition has been met. For example, the bonus trigger condition may be a predefined winning pattern for game symbols displayed in 306.

Alternatively, the bonus trigger condition may be unrelated to the game symbols, such as a count of total games played on the terminal, a predetermined time, or any other condition. If the bonus trigger condition has occurred, the terminal may proceed to 310 where a bonus game may be triggered.

If the bonus trigger condition has not occurred, the terminal may award any prizes won by the player based on the game symbols. The terminal may then proceed to 302 and await another game. The player may immediately begin another game.

In 310, the terminal may trigger a bonus game status. For example, the bonus game status may include special lights on the terminal indicating the bonus game status. For example, the bonus game may include a predetermined number of bonus spins, each spin including an increasing number of wild symbols.

In 312, the terminal may optionally display a transition screen into the bonus game.

In 314, the terminal may test whether all bonus games have been provided. If yes, the terminal may proceed to 330. If no, the terminal may proceed to 316.

In 316, the terminal may determine a quantity of wild symbols to display. For example, the quantity of wild symbols may increase as the bonus games are played, until a large quantity of wild symbols are displayed, thus increasing the player's probability of winning a bonus prize.

In 318, the terminal may display the bonus game. For example, the bonus game symbols may be displayed on a display of the terminal, and the player may visually see the symbols and determine whether he has won a prize or not. The bonus game may include a quantity of wild symbols.

In 320, the terminal may determine whether the bonus game resulted in a predetermined winning pattern. If so, the player may be entitled to a bonus prize. For example, wild symbols may represent any available symbol in the video slot game for purposes of determining whether a prize is to be awarded to the player.

If no, the terminal may proceed to 314.

In 322, the terminal may optionally determine the bonus prize from a prize structure. For example, the prize structure may associate a predetermined winning pattern with an associated prize. The terminal may determine what the winning pattern is and look up the appropriate prize.

In 324, the terminal may optionally multiply the bonus prize by a bonus multiplier. For example, the bonus multiplier may be previously awarded to the player responsive to a multiplier award trigger condition.

In 326, the terminal may optionally display the bonus prize won by the player. For example, the quantity of the prize may be displayed on a display of the terminal.

In 328, the terminal may award the bonus prize. For example, the bonus prize may be added to a cumulative bonus prize to be awarded at the end of the bonus game.

In an alternative embodiment, the terminal may dispense the bonus prize through a dispenser. For example, the bonus prize may be dispensed as currency, currency, a printed voucher, merchandise, or some other form of value.

In 330, the terminal may display an exit transition screen.

In 332, the procedure may end.

FIG. 4 illustrates an example video gaming machine (VGM), in accordance with an example embodiment of the present invention. For example, the VGM may be a video lottery terminal, a video slot machine, or any other terminal designed to provide a game of chance to a player. In an alternative embodiment, the VGM may be a non-video game terminal, such as a mechanical reel slot machine. A mechanical reel slot machine may replace the display screen with a quantity of reels which spin and display symbols to the player. In an alternative embodiment, the VGM may be in communication with a server. All processing and determination may be executed at the server, while the VGM receives user input, displays any output, and awards any prizes.

A video gaming machine 410 may be configured to conduct a game of chance. For example, a game of chance may be a slot machine game, a lottery, a video game, or another game of chance involving a wager. For example, the video gaming machine 410 may be a video poker game terminal, a VGM, a video slot machine, or a video game terminal. The video gaming machine 410 may be in communication with a server. Alternatively, the video gaming machine 410 may be a standard slot machine terminal.

The video gaming machine 410 may include a blinker 412. The blinker 412 may enclose a light source configured to blink on and off. For example, the blinker 412 may be configured to blink when a large prize is awarded from the video gaming machine 410.

The video gaming machine 410 may include a lighted display 414. For example, the lighted display 414 may include a logo, a game name or other visually attractive graphics. The lighted display 414 may alternatively be a liquid crystal display screen. For example, the lighted display 414 may be configured to display graphics and text.

The video gaming machine 410 may include a display screen 416. For example, the display screen 416 may be a liquid crystal display screen (LCD) or a cathode ray tube (CRT) screen. For example, the display screen 416 may enclose a viewable display area visible to a player. Alternatively, the display screen 416 may be a touch screen, configured to accept player inputs of touching the screen.

The display screen 416 may be configured to display a screen shot 440. For example, the screen shot 440 may be as depicted in FIGS. 1A to 1G.

The video gaming machine 410 may include a player's card accepter 418, a printer 420 and a currency accepter 432. For example, the player's card accepter 418 may accept a frequent player's card. The frequent player's card may include a player's identifying information and play history. Alternatively, the frequent player's card may include an identifier that is associated with a player's identifying information and wager history. For example, the printer 420 may be configured to print a voucher or ticket for the player. The currency accepter 432 may be configured to accept cash bills in various denominations for a player's wager. The currency accepter 432 may also be configured to accept printed vouchers and tickets.

The video gaming machine 410 may include input modules 422. For example, the input modules 422 may be a set of buttons. The input modules 422 may be configured to receive input from a player during a game of chance. Other forms of input modules may be used, for example, a mouse-pointer device or a voice recognition module.

The video gaming machine 410 may include a dispenser tray 424 and a dispenser 426. The dispenser 426 may be configured to dispense a prize. For example, a prize may be currency or a prize receipt redeemable at a cashier. The dispenser tray 424 may be configured to catch the prize after it is dispensed.

The video gaming machine 410 may include openings 428, 434 and 436. Opening 428 may be configured to allow sound through. For example, interior speakers may be located behind opening 428. The openings 434 and 436 may be configured to allow ambient air to circulate into and out of an interior of the video gaming machine 410. Ambient air circulation may assist in maintaining an optimal operating temperature for the video gaming machine 410.

The video game machine 410 may include a latch 430. For example, the latch 430 may be configured to release a front door of the video game machine 410 for opening. When the front door is opened, it may be possible for a technician to access an interior of the video game machine 410 for upgrades or maintenance.

FIG. 5 illustrates an example system for providing a game of chance, in accordance with an example embodiment of the present invention. For example, the system may include a terminal 500 which may be a VGM as depicted in FIG. 4. The VGM may be configured to provide a virtual slot machine game as described in FIGS. 1A, 1B, 1C, 1D, 1E, and 1F to a player. The VGM may be configured to execute the procedures depicted in FIGS. 2 and 3.

The terminal 500 may include a processor 502. The processor 502 may be configured to execute the procedures depicted in FIGS. 2 and 3. The processor 502 may be configured to provide screen shots as depicted in FIGS. 1A, 1B, 1C, 1D, 1E, and 1F to a display 504.

The terminal 500 may include a display 504. The display 504 may be configured to display the screen shots as depicted in FIGS. 1A, 1B, 1C, 1D, 1E, and 1F. The display 504 may be, for example, an LCD or a CRT display.

The terminal 500 may optionally include a network interface 506. The network interface 506 may be configured to communicate between the terminal 500 and a network. For example, the network interface 506 may be an Ethernet adaptor, a modem, or some other communication adaptor for converting information from the processor 502 into a form that can be carried over a communications network.

The terminal 500 may optionally include a prize structure 508. The prize structure 508 may include the prizes awarded in the game as well as winning patterns associated with each prize. For example, the prize structure 508 may include symbols that must be displayed in the elements on the VGM's display, as well as how they are arranged along predefined lines. For example, the prize structure 508 may include information depicted in FIGS. 6A and 6B.

The terminal 500 may include a dispenser 510. The dispenser 510 may award the player's prize when the player elects to cash out of the game. The dispenser 510 may be configured to dispense currency, such as coins, to award the prize.

Alternatively, the dispenser 510 may be a printer configured to print a voucher redeemable at a cashier for the prize.

Alternatively, the dispenser 510 may be configured to dispense merchandise or other physical goods as the prize. Alternatively, the dispenser 510 may be configured to dispense any suitable prize.

The terminal 500 may optionally include a play log 512. The play log 512 may be a log maintained by the terminal 500 of transactions. For example, transactions may include wagers provided to the terminal 500, prizes dispensed by the terminal 500, winning and non-winning spin results, a bet amount, selected predefined lines, a date and time of a virtual wheel spin, a frequent player identification, or any other information pertaining to the operation of the terminal 500.

For example, the information may be used for maintenance or audit purposes by the operator of the terminal 500. The terminal 500 may require maintenance after a predefined number of virtual spins or a predefined number or amount of prizes awarded. The operator of the terminal 500 may review the information to audit the performance of the game, for example, by checking for unusual patterns of prizes being awarded.

The terminal 500 may include an input device 518, such as a keypad, buttons, pointing device, scrolling wheels, or other conventional input devices. The input device 518 may be configured to receive inputs from the player required during the game.

It is understood that the terminal 500 may include more than one input device, though only one is depicted.

In an alternative embodiment, the display 504 may be a touch-sensitive screen which receives player inputs via the player touching the screen on displayed virtual buttons. In this example embodiment, an input device 518 may not be required.

The terminal 500 may be in communication with a server 516 over a network 514. The network 514 may be any communications link that may carry communications between the terminal 500 and the server 516. For example, the network 514 may be an Ethernet network, a local area network, a wide area network, a virtual private network over another network, the Internet, or any other network which can carry communications.

The server 516 may be a central server located at a location remote from the terminal 500. The server 516 may coordinate a plurality of terminals (not depicted) in the system distributed at multiple locations. The server 516 may function to centralize control of the terminals.

It will be understood that functionality included in the terminal 500 may alternatively be moved to the server 516.

It will be understood that the system may be a standalone terminal, without the network 514 or the server 516. A standalone terminal may be used when establishing a communication connection over a network to a server is cost-prohibitive or otherwise undesirable.

The terminal 500 may include a game control software 520, which is accessible to the processor 502. The game control software 520 may be configured to control the game of chance offered at the terminal 500.

The terminal 500 may include a game display control 522, which is accessible to the processor 502. The game display control 522 may be configured to control the display 504.

The terminal 500 may include a bonus game rules 524, which is accessible to the processor 502. The bonus game rules 524 may be configured to control the bonus game, if the bonus trigger condition is met and a bonus game is awarded to the player.

The terminal 500 may include a bonus play generating rules 526, which is accessible to the processor 502. The bonus play generating rules 526 may be configured to control play of the bonus game, if awarded to the player.

The terminal 500 may include a bonus game content 528, which is accessible to the processor 502. The bonus game content 528 may be configured to provide content for the bonus game, if awarded to the player.

FIG. 6A illustrates an example pay structure, in accordance with an example embodiment of the present invention. For example, the pay structure may be used in part to determine the prize awarded to a player in a virtual slot machine game. The prize may be further determined based on the player's wager amount. The prize may be awarded when a specified number of specific symbols appear on a predefined line. For example, predefined lines may be as depicted in FIG. 6B.

The pay structure may include symbols 600A, 600C, 600D, 600E, 600F, 600G, 600H, 600I, 600J, and 600K. For example, the symbols may be displayed in elements on a display in a VGM as depicted in FIG. 4. There may be additional symbols used in the game, for example, a bonus triggering symbol that triggers a bonus within the game.

Each symbol may be associated with a prize amount. The prize amount may be a multiplier used to multiply by the player's wager amount to determine the prize to be awarded. For example, the symbol 600A may be associated prize amounts 602A, 602B, 602C, and 602D.

The prize amount 602A may be used when the virtual spin results in 5 of the symbol 600A along a predefined line. The prize amount 602B may be used when the virtual spin results in 4 of the symbol 600A along a predefined line. The prize amount 602C may be used when the virtual spin results in 3 of the symbol 600A along a predefined line. The prize amount 602D may be used when the virtual spin results in 2 of the symbol 600A along a predefined line.

The pay structure may be stored in the VGM in a variety of data structures, for example, on write-once memory or other machine-readable memory.

FIG. 6B illustrates an example pay line structure, in accordance with an example embodiment of the present invention. The pay lines may be predefined and used in conjunction with the pay structure depicted in FIG. 6A to determine a prize to be awarded a player in a virtual slot machine game played on a VGM.

The predefined pay lines may be stored in the VGM in a variety of data structures, for example, on write-once memory.

It will be appreciated that the procedures and methods described may be in the form of machine-executable instructions stored on a machine-readable medium. The procedures and methods may be thus read from the medium and executed by a machine to execute the procedure or method.

### MODIFICATIONS

In the preceding specification, the present invention has been described with reference to specific example embodiments thereof. It will, however, be evident that various modifications and changes may be made thereunto without departing from the broader spirit and scope of the present invention as set forth in the claims that follow. The specification and drawings are accordingly to be regarded in an illustrative rather than restrictive sense.

1. A system for facilitating play of a game of chance, comprising:
an input device configured to receive a player indication of a desire to play the game;
a display configured to
display a set of displayed game symbols simulating slot machine reels responsive to the player indication, and
responsive to a predefined bonus trigger condition, sequentially displaying sets of displayed bonus symbols simulating slot machine reels, wherein each set of displayed bonus symbols includes a quantity of wild symbols; and
a processor in communication with the input device and the display, the processor configured to
determine the set of displayed game symbols based on predefined rules, wherein each displayed game symbol is selected from a set of available game symbols,
determine the sets of displayed bonus symbols based on the predefined rules, wherein each displayed bonus symbol is selected from the set of available game symbols, and
awarding a prize if a set of displayed bonus symbols are in a predefined symbol pattern, wherein a wild symbol may represent any symbol from the set of available game symbols.

2. The system of claim 1, wherein the bonus trigger condition is the set of displayed game symbols being in a predefined bonus trigger pattern.

3. The system of claim 1, wherein the bonus trigger condition is the set of displayed game symbols including a bonus trigger symbol.

4. The system of claim 1, wherein the quantity of wild symbols increases after each set of bonus spin symbols.

5. The system of claim 1, wherein each wild symbol replaces one of the displayed bonus symbols after the displayed bonus symbols are displayed.

6. The system of claim 1, wherein each wild symbol is associated with a display location and replaces a displayed bonus symbol associated with the display location after the displayed bonus symbols are displayed.

7. The system of claim 6, wherein each display location is randomly selected.

8. The system of claim 1, wherein the wild symbols are added to the displayed bonus symbols before the displayed bonus symbols are displayed.

9. The system of claim 1, further comprising:
a dispenser for dispensing the prize to the player.

10. The system of claim 1, further comprising:
a prize structure, the prize structure mapping a predefined winning set of bonus symbols with a prize.

11. The system of claim 1, further comprising:
a payment receiving device for receiving a payment from the player prior to displaying the set of displayed game symbols, the payment receiving device communicating to the processor that the payment has been received.

12. The system of claim 1, further comprising:
a network interface in communication with a server over a network.

13. The system of claim 11, wherein the network is the Internet.

14. The system of claim 11, wherein
the processor is located at the server, and
the network interface, the input device, and the display are located at a terminal.

15. A method for facilitating play of a game of chance, comprising:
responsive to a player indication of a desire to play the game, displaying a set of displayed game symbols to the player;
responsive to a bonus trigger condition, sequentially displaying sets of displayed bonus symbols to the player, each set of bonus symbols including a quantity of wild symbols; and
awarding a prize to the player, wherein the prize is determined based on the sets of displayed bonus symbols.

16. The method of claim 15, wherein the bonus trigger condition occurs when the set of displayed game symbols are in a predefined bonus trigger pattern.

17. The method of claim 15, wherein the bonus trigger condition occurs when a bonus trigger symbol is displayed with the displayed game symbols.

18. The method of claim 15, wherein the quantity of wild symbols increases from one set of displayed bonus symbols to the next.

19. The method of claim 15, wherein each wild symbol replaces one of the displayed bonus symbols after the displayed bonus symbols are displayed.

20. The method of claim 15, wherein each wild symbol is associated with a display location and replaces a displayed bonus symbol associated with the display location after the displayed bonus symbols are displayed.

21. The method of claim 20, wherein each display location is randomly selected.

22. The method of claim 15, wherein the wild symbols are added to the displayed bonus symbols before the displayed bonus symbols are displayed.

23. The method of claim 15, further comprising:
dispensing the prize to the player from a dispenser.

24. The method of claim 15, wherein the prize is determined by looking up a prize structure, the prize structure mapping a predefined winning set of displayed bonus symbols with a prize.

25. The method of claim 15, further comprising:
receiving a payment from the player prior to providing the game of chance.

26. The method of claim 15, further comprising:
a network interface in communication with a server over a network.

27. The method of claim 15, wherein the network is the Internet.

28. The method of claim 15, wherein the game of chance is a video keno game, and
the displayed game symbols and the displayed bonus symbols are keno spots.

29. The method of claim 15, wherein the game of chance is a video poker game, and
the displayed game symbols and the displayed bonus symbols are virtual poker cards.

30. The method of claim 15, wherein the game of chance is a video slot machine game, and
the displayed game symbols and the displayed bonus symbols simulate slot machine wheels.

31. A computer readable medium including instructions configured to be executed on a processor, so that the processor performs the steps of claim 15.
